(19) United States
(12) Patent Application Publication
(10) Pub. No.: US 2025/0224923 A1
(43) Pub. Date: Jul. 10, 2025

(54) FLOATING-POINT COMPUTATION DEVICE AND METHOD

(71) Applicant: Taiwan Semiconductor Manufacturing Company, Ltd., Hsinchu (TW)

(72) Inventors: Xiaochen PENG, Hsinchu (TW); Brian Crafton, Hsinchu (TW); Murat Kerem Akarvardar, Hsinchu (TW); Hidehiro Fujiwara, Hsinchu (TW); Haruki Mori, Hsinchu (TW)

(21) Appl. No.: 18/655,745

(22) Filed: May 6, 2024

Related U.S. Application Data
(60) Provisional application No. 63/617,508, filed on Jan. 4, 2024.

(51) Int. Cl. G06F 7/487

(52) U.S. Cl. CPC G06F 7/4876

(57) ABSTRACT

In some embodiments, a computing method includes, for pairs of a first and second floating-point numbers, each having a respective mantissa and exponent, supplying to a respective one of multiply circuits the mantissas of a subset of the pairs of first and second floating-point number, the subset of the plurality of pairs of first and second floating-point numbers each having a respective sum of the exponents of the first and second floating-point numbers, respectively, meeting a predetermined criterion, such as the sum being smaller than a predetermined threshold value; generating, using each of the plurality of multiply circuits, a product of the mantissas of the respective pair of first and second floating-point numbers; accumulating the product mantissas to generate a product mantissa partial sum; combining the product mantissa partial sum and maximum product exponent to generate an output floating point number; and for each of the remaining pairs of first and second floating-point numbers: withholding the mantissas from respective multiply circuits, disabling the respective multiply circuits, or both. A trained AI model can be used to determine the threshold value. Various components for the multiplication and accumulation steps can be disabled for the pairs of numbers not meeting the criterion by a control signal.

### CROSS REFERENCE TO RELATED APPLICATIONS

This application claims the benefit of U.S. Provisional Application Ser. No. 63/617,508, filed Jan. 4, 2024, which provisional application is incorporated herein by reference in its entirety.

### BACKGROUND

This disclosure relates generally to floating-point arithmetic operations in computing devices, for example, in in-memory computing, or compute-in-memory (“CIM”) devices and application-specific integrated circuits (“ASICs”), and further relates to methods and devices used data processing, such as multiply-accumulate (“MAC”) operations. Compute-in-memory or in-memory computing systems store information in the main random-access memory (RAM) of computers and perform calculations at memory cell level, rather than moving large quantities of data between the main RAM and data store for each computation step. Because stored data is accessed much more quickly when it is stored in RAM, compute-in-memory allows data to be analyzed in real time. ASICs, include digital ASICs, are designed to optimize data processing for specific computational needs. The improved computational performance enables faster reporting and decision-making in business and machine learning applications in such applications as artificial intelligence (“AI”) accelerators. Efforts are ongoing to improve the performance of such computational memory systems, and more specifically floating-point arithmetic operations in such systems.

### BRIEF DESCRIPTION OF THE DRAWINGS

Aspects of the present disclosure are best understood from the following detailed description when read with the accompanying drawings. It is noted that, in accordance with the standard practice in the industry, various features are not drawn to scale. In fact, the dimensions of the various features may be arbitrarily increased or reduced for clarity of discussion. In addition, the drawings are illustrative as examples of embodiments of the invention and are not intended to be limiting.

FIG. 1 outlines a method for a multiply-accumulate (“MAC”) operation according to some embodiments.

FIG. 2 outlines a process of determining a threshold value for excluding a number from a MAC operation, in accordance with some embodiments.

FIG. 3 schematically illustrate a device for carrying out MAC operations in accordance with some embodiments.

FIG. 4 illustrate storage bit reduction as a result of employing pre-multiplication mantissa alignment in MAC operations, in accordance with some embodiments.

FIG. 5 schematically illustrate a device for carrying out MAC operations in accordance with some embodiments.

FIG. 6 schematically illustrate a device for carrying out MAC operations in accordance with some embodiments.

FIG. 7 schematically illustrate a device for carrying out MAC operations in accordance with some embodiments.

FIG. 8 is a block diagram illustrating a computer system that is programmed to implement computational operations in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the drawings. The spatially relative terms are intended to encompass different orientations of the device in use or operation in addition to the orientation depicted in the drawings. The apparatus may be otherwise oriented (rotated 90 degrees or at other orientations) and the spatially relative descriptors used herein may likewise be interpreted accordingly.

This disclosure relates generally to floating-point arithmetic operations in computing devices, for example, in in-memory computing, or compute-in-memory (“CIM”) devices and application-specific integrated circuits (“ASICs”), and further relates to methods and devices used data processing, such as multiply-accumulate (“MAC”) operations. Computer artificial intelligence (“AI”) uses deep learning techniques, where a computing system may be organized as a neural network. A neural network refers to a plurality of interconnected processing nodes that enable the analysis of data, for example. Neural networks use “weights” to perform computation on new input data. Neural networks use multiple layers of computational nodes, where deeper layers perform computations based on results of computations performed by higher layers.

CIM circuits perform operations locally within a memory without having to send data to a host processor. This may reduce the amount of data transferred between memory and the host processor, thus enabling higher throughput and performance. The reduction in data movement also reduces energy consumption of overall data movement within the computing device. Alternatively, MAC operations can be implemented in other types of system, such as a computer system programmed to carry out MAC operations.

In a MAC operation, a set of input numbers are each multiplied by a respective one of a set of weight values (or weights), which may be stored in a memory array. The products are then accumulated, i.e., added together to form an output number. In certain applications, such as neural networks used in machine learning in AI, the output resulted from MAC operation can be used as a new input value in a succeeding layer of the neural network. An example of the mathematical description of the MAC operation is shown below.

$${O}_{J} = {\sum }_{I = 1}^{h - 1} ( {A}_{I} \times {W}_{IJ} ) , \qquad ( 1 )$$

where A_{I} is the I-th input, W_{IJ} is the weight corresponding to the I-th input and J-th weight column. O_{J} is the MAC output of the J-th weight column, and h is the accumulated number.

In a floating-point (“FP”) MAC operation, a FP number can be expressed as a sign, a mantissa, or significand, and an exponent, which is an integer power to which the base is raised. A product of two FP numbers, or factors, can be represented by the product of the mantissas (“product mantissa”) and sum of exponents of the factors. The sign of the product can be determined according to whether the signs of the factors are the same. In a binary floating-point (“FP”) MAC operation, which can be implemented in digital devices such as digital computers and/or digital CIM circuits, each FP factor can be stored as a mantissa of a bit-width (number of bits), a sign (e.g., a single sign bit, S (1_{b} for negative; 0 for non-negative), the sign for the mantissa, and the floating-point number being (−1)^{S}), and an integer power to which the base (i.e., 2) is raised. In some representation schemes, a binary FP number is normalized, or adjusted such that the mantissa is greater than or equal to 1_{b} but less than 10_{b}. That is, the integer portion of a normalized binary FP number is 1_{b}. In some hardware implementations, the integer portion (i.e., 1_{b}) of a normalized binary FP number is a hidden bit, i.e., not stored, because 1_{b} is assumed. In some representation schemes, A product of two FP numbers, or factors, can be represented by the product mantissa, a sum of the exponent of the factors, and a sign, which can be determined, for example, by comparing the signs of the factors, or by a sum of the sign bits or the least significant bit (“LSB”) of the sum.

To implement accumulation part of a MAC operation, in some procedures, the product mantissas are first aligned. That is, if necessary, at least some of the product mantissas are modified by appropriate orders of magnitude so that the exponents of the product mantissas are all the same. For example, product mantissas can be aligned by reducing at least some of the product mantissas appropriate orders of magnitude, such as by right-shifting the mantissas, to have all exponents be the maximum exponent of pre-alignment product mantissas. The order of magnitude by which a (i-th) product mantissas, PD_{M}[i], is reduced is the difference, E_{Δ}[i] (“delta exponent”), between the difference between the pre-alignment exponent PD_{E}[i] and the maximum exponent, PD_{E-MAX} (E_{Δ}[i]=PD_{E-MAX}−PD_{E}[i]). Aligned product mantissas can then be added together (algebraic sum) to form the mantissa of the MAC output, with the maximum exponent of pre-alignment product mantissas.

In accordance with certain aspects of the present disclosure, product mantissas with pre-alignment exponents significantly smaller than the maximum exponent are excluded (or “skipped”) from the accumulation part of the MAC operation. In some embodiments, pre-alignment product mantissas with delta exponents equal to, or greater than, a predetermined threshold value, T, are excluded. In some embodiments, the threshold value, T, is determined at least in part based on its impact on the inference accuracy for an AI model trained weight values applied to test data (similar to training data used in establishing an AI model).

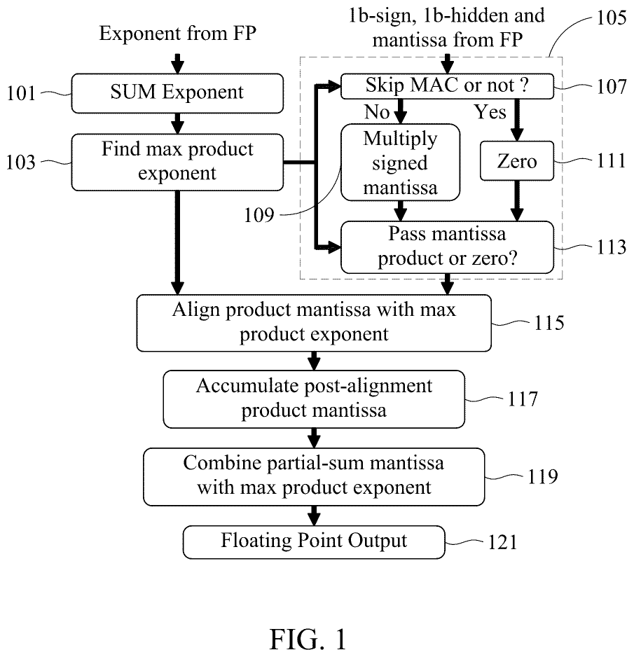

Referring to FIG. 1, in a example embodiment, in a MAC process for a set of pairs of FP numbers, such as weight values and input activations, the exponents of each pair of the FP number are summed 101 to generate a respective product exponent. Next, the maximum exponent of the product exponent is determined 103, for example by one or more comparators or microprocessors.

The maximum product exponent is then used to determine 105 the values to pass forward in the MAC process. In this example, for each of the pairs of FP number, a determination is made 107 on whether to exclude the product mantissa from the MAC operation. The determination 107 in some embodiments is based the based on the delta exponent, which depends on the maximum product exponent. If the outcome of the determination 107 is negative, a product mantissa, i.e., product of the mantissas, with associated signs, of the pair of FP numbers generated; if the outcome of the determination 107 is affirmative, a null output, such as 0_{b}, is generated 111 without carrying out a mantissa multiplication. The maximum product exponent in this example is also used as a basis (e.g., through delta exponent) to select 113 the output (product mantissa or zero) to the used in further steps in the MAC process. The selection 113 can be done by, for example, using multiplexers, with a signal indicative of the delta exponent relative to a threshold value applied to the selection input, and the product mantissa and zero applied to the respective data inputs.

Next, the non-zero product mantissas generated in step 105 and passed forward 113 are aligned 115 with each other using the maximum product exponent as outlined above. The post-alignment mantissas are accumulated 117 to generate a partial-sum mantissa. The partial-sum mantissa is then combined 119 with the maximum product exponent. In this example, “combine” means providing the partial-sum mantissa and the maximum product exponent in the computation system in a way that can be utilized by the system in subsequent operations. For example, the combination can include an l-bit sign, followed by an m-bit exponent, followed by an n-bit mantissa, where l, m, and n are predetermined based on the format of FP numbers used. Finally, the combination is output 121 as a floating-point number. In some embodiments, the output step 121 includes normalization, as described above.

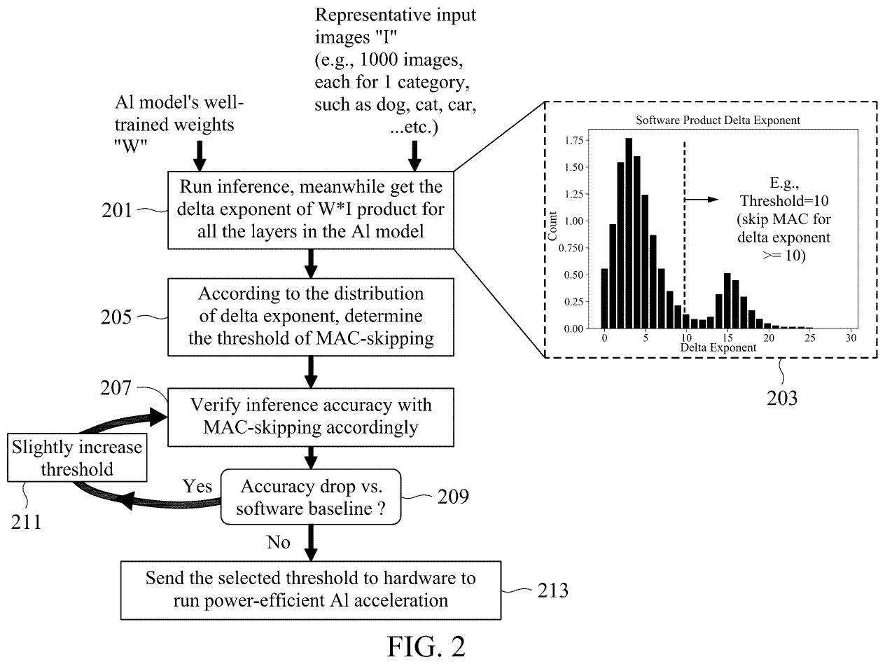

The decision 107 on whether to exclude a product mantissa from a MAC process is made, in some embodiments, based the delta exponent relative to a threshold value. The threshold value, T, is determined at least in part based on its impact on the inference accuracy for a trained AI model applied to test data. An example process for determining the threshold value is outlined in FIG. 2. In this example, the threshold value is to be determined for an AI model for classification of objects. Inference runs 201 are carried out using a trained AI model, i.e., one having trained weight values. The input data can be, for example, images of objects of various categories, such as dogs, cats, cars, etc., and the output run is labels generated by the AI model. For example, a number (e.g., 1000) of input images, one for each category of objects, can be used.

In this example, the process of determining the threshold value is based on algorithm-hardware co-optimization, where the threshold value is pre-determined at the algorithm-level, by examining the distribution of product delta exponent and verifying that no degradation in inference accuracy with MAC-skipping (i.e., MAC operation with the product mantissas set to zero for the FP number pairs having product exponents equal to or greater than the threshold) as compared to a baseline accuracy, which can be established with software inference runs on GPU or CPU using FP32 or FP16 data format without any MAC-skipping. In the example shown in FIG. 2, the weight-input product delta exponents for all layers of the AI model are computed using a software-based AI model, and the delta exponent distribution (an example of which for a specific input image is shown at label 203) are used to determine 205 an initial threshold value for MAC-skipping. For example, an initial threshold value may be chosen at a point where a large percentage (e.g., 75% or 80%) of the products are included in the MAC operation and/or beyond the trailing edge of a dominant peak. In other examples, threshold values sufficiently large based on experience can be chosen.

In this example, the initial threshold value is then used to verify 207 the accuracy of the AI model with MAC-skipping. The accuracy with MAC-skipping based on the initial threshold value is compared 209 with the software baseline accuracy. If the inference accuracy with MAC-skipping is lower than the baseline accuracy by more than an acceptable amount, threshold value is slightly increased 211 (for example by 1 or 2), and the AI model with MAC-skipping is run again to verify 207 the accuracy. The verification process is repeated until the inference accuracy is acceptable. The final threshold value can then be selected for hardware implementation of the AI model.

Conversely, in some embodiments, if the initial threshold value results in an acceptable inference accuracy, smaller threshold values can be tested until the accuracy decreases to an unacceptable level, and the largest threshold value that still resulted in an acceptable level of accuracy can then be selected for hardware implementation of the AI model. In either case, a larger threshold value than barely acceptable may be selected for hardware implementation of the AI model.

Analyses have shown that using a sufficiently large delta exponent threshold value that also reduces a significant amount of MAC operation can achieve substantially the same levels of inference accuracy as software baseline accuracies. In an example, as show in the table below, a threshold level of 10_{d} results in a 20% reduction in MAC operation; a threshold level of 8_{d} results in a 25% reduction in MAC operation. In both cases the inference accuracy, as measured by the top-1 and top-5 accuracies, remains substantially the same as the software baseline accuracy.

| | | Inference Accuracy (%) | |
|---|---|---|---|
| Accuracy Comparison | % of MAC-skip | Top-1 | Top-5 |
| FP32 Software Baseline | — | 72.29 | 90.19 |
| Skip MAC when E_{Δ} ≥10 | 20% | 72.34 | 90.21 |
| Skip MAC when E_{Δ} ≥8 | 25% | 72.24 | 90.17 |

The selected threshold value resulting from the process described above can be sent 213 to, or otherwise used in, hardware implementing the AI model with MAC-skipping.

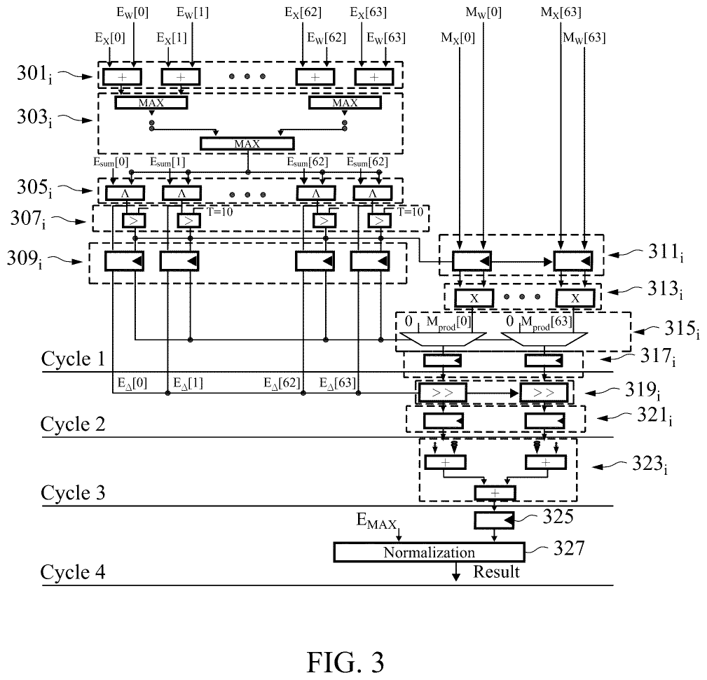

An example of a computing device capable of MAC operation with MAC-skipping is shown in FIG. 3. The device in this example, includes a set of n (in this example 64) adders 301ᵢ, where i=0 through n−1. Each adder 301ᵢ receives a respective pair of input exponent E_{X}[i] and weight exponent E_{W}[i] and generates a sum of each pair of exponents. The computing device further includes a set of circuits connected to the outputs of the adders 301ᵢ to receive the product exponents and determine the maximum product sum. In some embodiments, the circuits include n−1 circuits 303ᵢ in log₂ n layers. Each of the circuits 303ᵢ in this example receives a pair of product exponents and outputs the maximum (greater) of the two exponents. The first layer of n/2 circuits 303ᵢ receive the inputs from the adders 301ᵢ; each successive layer of the circuits 303ᵢ has half the number of circuits 303ᵢ of the previous layer, and each output the maximum of the two product exponents received. The last layer has a single circuit 303ᵢ and outputs the maximum product exponent of all products exponents the adders 301ᵢ. Any suitable circuit for selecting, sorting or other data handling based on relative values of numbers can be used. For example, a digital comparator can be used to compare a pair of product exponents, and the output of the comparator can be applied to the select line(s) of a multiplexer to select the greater of the two of product exponents received at the inputs of the multiplexer.

The computing device in this example further includes a set of subtractors 305ᵢ, each of which receives as inputs a respective product exponent, E_{SUM}[i], and the maximum product exponent, and outputs the difference, E_{Δ}[i], between the product exponent and maximum product exponent, or delta exponent. The computing device in this example further includes a set of comparators 307ᵢ, each of which receives as inputs a respective delta exponent, E_{Δ}[i], and the threshold value, T, for delta exponents, and outputs a control signal indicative of the relationship between E_{Δ}[i] and T. For example, the control signal can be a single-bit binary number, with 0 for E_{Δ}[i]<T and 1 for E_{Δ}[i]≥T. The computing device in this example further includes a set of registers 309ᵢ, each of which receives as inputs a respective delta exponent, E_{Δ}[i], and the control signal from the respective comparator 307ᵢ exponents, and stores either the delta exponent or zero depending on the output of the comparator. Each register 309ᵢ also stores the control signal from the respective comparator 307ᵢ.

Other devices that are capable of generating different outputs depending on the relative values of delta exponent and threshold value. For example, subtractors can be used to subtract the threshold value from the delta exponents, and the sign bits of the results can be used as the control signals. Alternatively, the threshold value can be added to the product exponents, and the sums subtracted from the maximum product exponent using subtractors 305ᵢ. The sign bits of the differences can be used as the control signals. As a further alternative, the threshold value can be subtracted from the maximum product exponent, and the difference used to subtract the product exponents using subtractors 305ᵢ. The sign bits of the differences can be used as the control signals. This alterative has the advantage of using a single subtractor, rather than multiple subtractors or comparators, reducing both the number of components and associated operations. For the two alternatives, the product exponent inputs to the registers 309ᵢ can be taken directly from the outputs of the adders 301ᵢ instead of the outputs of the subtractors 305ᵢ.

The computing device in this example further includes registers 311ᵢ, each of which receives as inputs a respective pair of input mantissa, M_{X}[i], and weight mantissa M_{W}[i], and the output signal of a respective comparator 307ᵢ. Each register 311ᵢ stores either the input and weight mantissas or zeros depending on the output of the comparator control signal from the respective comparator 307ᵢ. In some embodiments, if the delta exponent is equal to, or greater than, the threshold value, T, the register 311i stores zero; if the delta exponent is less than the threshold value, T, the register 311i stores the input and weight mantissas.

The computing device in this example further includes multiply circuits 313ᵢ, each of which receives as inputs the respective pair of input mantissa, M_{X}[i], and weight mantissa, M_{W}[i], stored in a respective register 311ᵢ. Each of the multiply circuit 313ᵢ outputs a respective product mantissa, M_{PROD}[i], which is the product of the input mantissa, M_{X}[i], and weight mantissa, M_{W}[i], stored in a respective register 311ᵢ. Multiplication between weight values and respective input activations can be carried out in a multiply circuit, which can be any circuit capable of multiplying two digital numbers. For example, U.S. patent application Ser. No. 17/558,105, published as U.S. Patent Application Publication No. 2022/0269483 A1 and U.S. patent application Ser. No. 17/387,598, published as U.S. Patent Application Publication No. 2022/0244916 A1, both of which are commonly assigned with the present application and incorporated herein by reference, disclose multiply circuits used in CIM devices. In some embodiments, a multiply circuit includes a memory array that is configured to store one set of the FP numbers, such as weight values; the multiply circuit further includes a logic circuit coupled to the memory array and configured to receive the other set of FP numbers, such as the input values, and to output signals, each based on a respective stored number and input number, and being indicative of product of the stored number and respective input number.

The computing device in this example further includes selecting circuits, such as multiplexers 315ᵢ, each of which receives as data inputs the product mantissa, M_{PROD}[i], from the respective multiply circuit 313ᵢ and zero, and as select input the control signal stored in the respective register 309ᵢ. Each of the multiplexers 315ᵢ outputs the input selected by the control signal. For example, if E_{Δ}[i]≥T, zero is selected for output; if E_{Δ}[i]<T, M_{PROD}[i] is selected for output. The output from each of the multiplexers 315ᵢ is then stored in registers 317ᵢ.

The computing device in this example further includes product mantissa alignment circuits, such as shifters 319ᵢ, each of which receives as inputs the product mantissa, M_{PROD}[i], or zero stored in a respective of the registers 317ᵢ and delta exponent, E_{Δ}[i]), and right-shifts the M_{PROD}[i] by E_{Δ}[i] bits to generate a respective post-alignment product mantissa, which is stored in the respective register 321ᵢ. The post-alignment product mantissas are accumulated, or summed, by an accumulator, such as an adder tree 323ᵢ. The sum of the product mantissas, now excluding those for which E_{Δ}[i]≥T, is stored in a register 325. Finally, the product mantissa stored in the register 325 is then combined with the maximum product exponent in a normalization circuit 327 to form a floating-point MAC output.

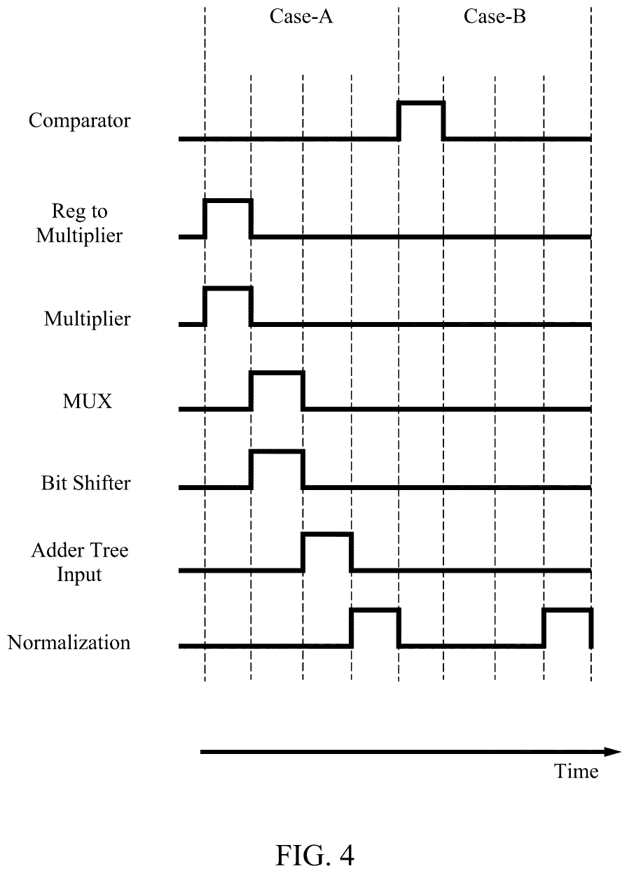

Thus, according to some embodiments, a MAC operation proceeds without generating product mantissas depending on the result of comparison between the product exponent and maximum product exponent, as illustrated by the example timing diagrams shown in FIG. 4. In the first part of the timing diagram, “Case-A,” the calculated product delta exponent for a pair of input and weight is smaller than or equal to threshold value. For this case, the comparator output is 0, signaling that the product mantissa is not excluded from MAC operations and is run according to the regular MAC process: First, input and weight mantissas are loaded into the multiply circuit, or multiplier and the product of the two, i.e., the product mantissas, are generated by the multiplier. Next, the product mantissa is selected by multiplexer and bit-shifted in the mantissa alignment operation. Next, the post-alignment product mantissa is accumulated by the adder tree. Finally, the accumulated product mantissa is normalized.

In the second part of the timing diagram, “Case-B,” the calculated product delta exponent for a pair of input and weight is greater than the threshold value. For this case, the comparator output is 1, signaling that the product mantissa is excluded from MAC operations. Thus, loading of input and weight mantissas from the register into the multiplier is disabled; the multiplier itself is disabled; zero is selected by the multiplexer; no alignment (bit shifting) is carried out for product mantissas with a value of zero; the input into the adder tree is zero; and the normalization is carried out for the non-skipped product mantissas.

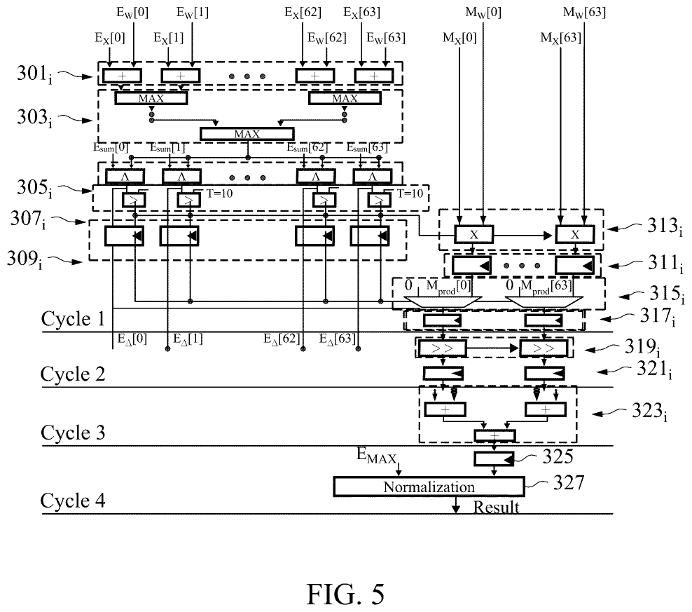

In some embodiments, as shown by the example illustrated in FIG. 5, a computer device for implementing MAC operations with MAC-skipping is similar to the device shown in FIG. 3, but the outputs of the comparators 307ᵢ are connected to the multiply circuit 313ᵢ to disable multiplication, instead of being connected to the registers 311ᵢ to disable loading of the input and weight mantissas to the multiply circuits 313ᵢ, for delta exponents greater than or equal to the threshold value. In this example, the input mantissas, M_{X}[i], and weight mantissas, M_{W}[i], are input directly to the multiply circuits 313ᵢ, and the outputs of the multiply circuits are stored in the respective registers 311ᵢ.

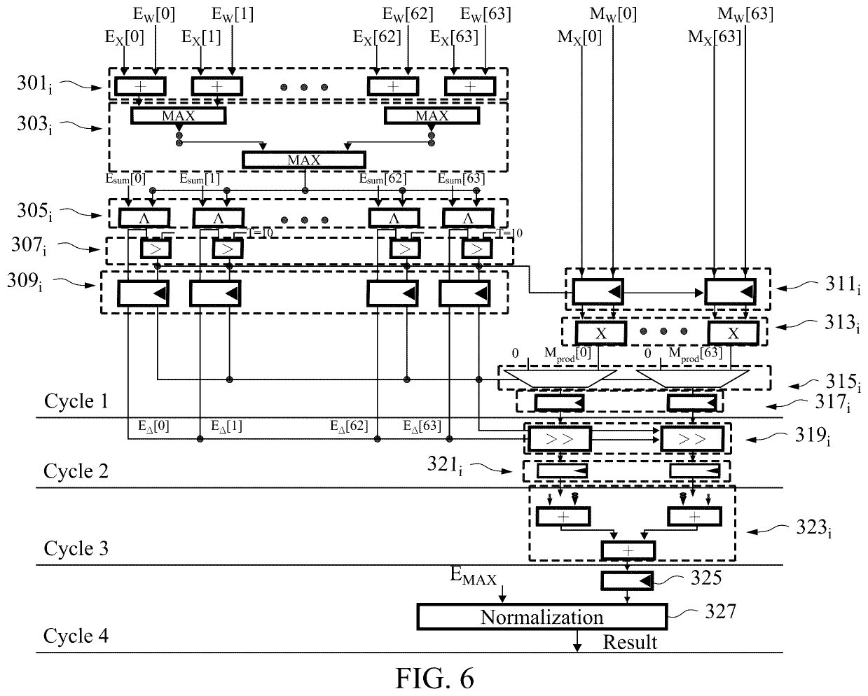

In some embodiments, as shown by the example illustrated in FIG. 6, a computer device for implementing MAC operations with MAC-skipping is similar to the device shown in FIG. 3, but the outputs of the comparators 307ᵢ are further connected to the shifters 319ᵢ to disable mantissa alignment for delta exponents greater than or equal to the threshold value.

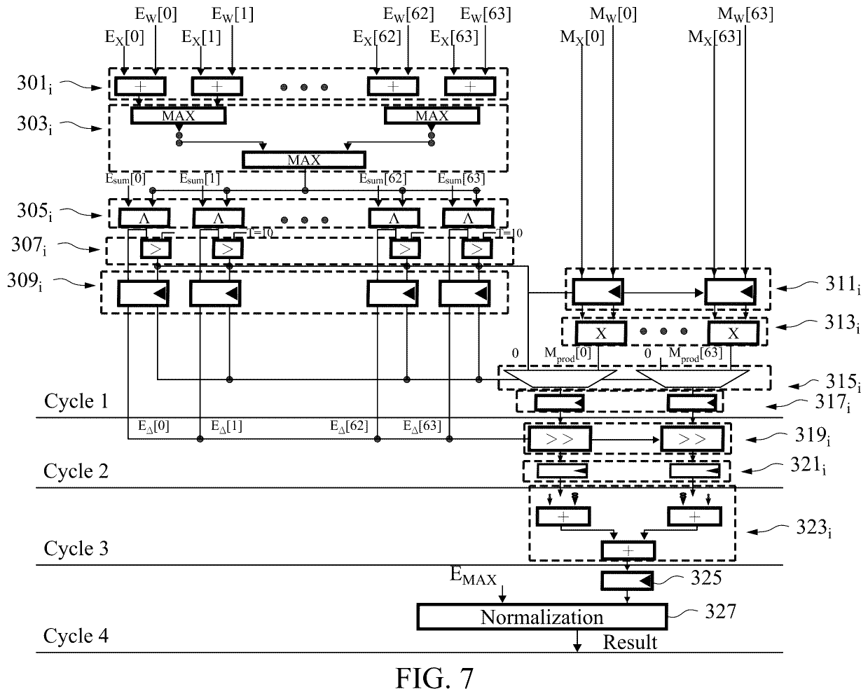

In some embodiments, as shown by the example illustrated in FIG. 7, a computer device for implementing MAC operations with MAC-skipping is similar to the device shown in FIG. 3, but the outputs of the comparators 307ᵢ are further connected to the multiplexers 315ᵢ to supply the selected input for delta exponents greater than or equal to the threshold value. In this specific example, the comparator output supplied to the multiplexer input is 0 when a delta exponent is greater than or equal to the threshold value. The 0 value can be supplied directly from the comparators or, in the case where the output of comparators is 1 for a delta exponent greater than or equal to the threshold value, through an inverter.

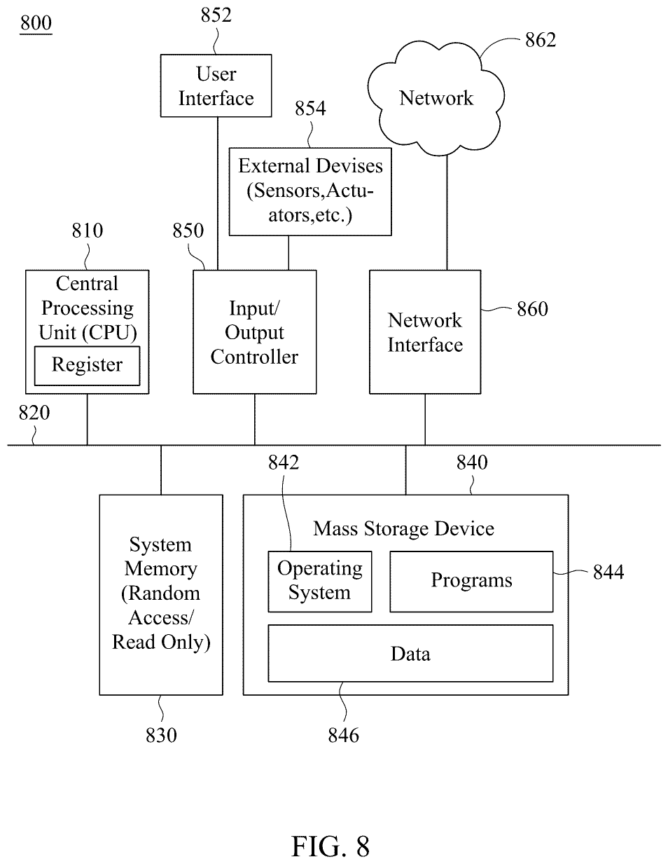

The computing method described above can be implemented by the specific computing systems described above but can be implemented by any suitable system. For example, as an alternative to performing the mantissa multiplications in CIM memory, a processor-based operation can be used, for example, in a computer programed to perform algorithms outlined above. For example, a computer system 800 shown in FIG. 8 can be used. In this example, the computer 800 includes a processor 810, which can include register 812 and is connected to the other components of the computer via a data communication path such as a bus 820. The components include system memory 830, which is loaded with the instructions for the processor 810 to perform the methods described above. Included is also a mass storage device, which includes a computer-readable storage medium 840. The mass storage device is an electronic, magnetic, optical, electromagnetic, infrared, and/or a semiconductor system (or apparatus or device). For example, the computer-readable storage medium 840 includes a semiconductor or solid-state memory, a magnetic tape, a removable computer diskette, a random access memory (RAM), a read-only memory (ROM), a rigid magnetic disk, and/or an optical disk. In one or more embodiments using optical disks, the computer-readable storage medium 840 includes a compact disk-read only memory (CD-ROM), a compact disk-read/write (CD-R/W), and/or a digital video disc (DVD). The mass storage device 840 stores, among other things, the operating system 842; programs 844, including those that, when read into the system memory 820 and executed by the processor 810, cause the computer 800 to carry out the processes described above; and Data 846. The computer 800 also includes an I/O controller 850, which inputs and outputs to a User Interface 852. The User Interface 852 can include, for example, various parts of the vehicle instrument cluster, audio devices, a video display, input devices such as buttons, dials, a touch-screen input, a keyboard, mouse, trackball and any other suitable user interfacing devices. The I/O controller 850 can have further input/out ports for input from, and/or output to, devices such as External Devices 854, which can include sensors, actuators, external storage devices, and so on. The computer 800 can further include a network interface 860 to enable the computer to receive and transmit data from and to remote networks 862, such as cellular or satellite data networks, which can be used for such tasks as remote monitoring and control of the vehicle and software/firmware updates.

Certain examples described in this disclosure omit resource-intensive computational steps, such as multiplications, that would generate results that have negligible impact on the accuracy of overall outcome of the entire computational process, such as MAC. Such omissions can result in significant reduction in overall computation steps without sacrificing accuracy. Such reduction can significantly increase the efficiency of computational devices such as general digital ASIC AI accelerators and digital CIM or near-memory computing (“NMC”) macros.

In sum, in some embodiments, a computing method includes: for a first set of floating-point numbers and corresponding second set of floating-point numbers, each having a respective mantissa and exponent, selecting a subset of the first set of floating-point numbers and corresponding subset of the second set of floating-point numbers at least in part based on the exponents of the first set of floating-point numbers and corresponding second set of floating-point numbers, generating, using a multiply circuit, a product between each of the subset of the first set of floating-point numbers and a respective one of the subset of second set of floating-point numbers; and accumulating the products to generate a product partial sum.

In addition, according to some embodiments, a computing method includes: for a set of pairs of a first and second floating-point numbers, each of the first and second floating-point numbers having a respective mantissa and exponent, supplying to a respective one of a set of multiply circuits the mantissas of a subset of the set of pairs of first and second floating-point numbers, the subset of the set of pairs of first and second floating-point numbers each having a respective sum of the exponents of the first and second floating-point numbers, respectively, meeting a predetermined criterion; generating, using each of the set of multiply circuits, a product of the mantissas of the respective pair of first and second floating-point numbers; accumulating the product mantissas to generate a product mantissa partial sum; combining the product mantissa partial sum and maximum product exponent to generate an output floating point number; and for each of the remaining pairs of first and second floating-point numbers: withholding the mantissas from respective multiply circuits, disabling the respective multiply circuits, or both.

Further, according to some embodiments, a computing device includes: multiply circuits, each configured to receive as inputs a respective pair of first and second binary numbers, and generate a product of the received first and second binary numbers; multiplexers, each having a first and second data inputs and a select input, and configured to receive at the first data inputs the product generated by a respective one of the multiply circuits and at the second data inputs a second input, and selectively output the received product or the second input; an accumulator configured to generate a sum of a set of binary numbers, each indicative of the output of a respective one of the multiplexers; and comparators, each having a first and second inputs and an output, and configure to receive at the first input a respective input signal and receive at the second input a common input signal for all comparators, the select inputs of the multiplexers being connected to the outputs of respective ones of the comparators.

This disclosure outlines various embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A computing method, comprising:
for a first plurality of floating-point numbers and corresponding second plurality of floating-point numbers, each having a respective mantissa and exponent, selecting a subset of the first plurality of floating-point numbers and corresponding subset of the second plurality of floating-point numbers at least in part based on the exponents of the first plurality of floating-point numbers and corresponding second plurality of floating-point numbers;
generating, using a multiply circuit, a product between each of the subset of the first plurality of floating-point numbers and a respective one of the subset of second plurality of floating-point numbers; and
accumulating the products to generate a product partial sum.

2. The computing method of claim 1, wherein the selecting a subset of the first plurality of floating-point numbers and corresponding subset of the second plurality of floating-point numbers at least in part based on the exponents of the first plurality of floating-point numbers and corresponding second plurality of floating-point numbers comprises selecting a subset of the first plurality of floating-point numbers and corresponding subset of the second plurality of floating-point numbers at least in part based on a difference (“delta exponent”), between a sum of the exponents of each pair of the first floating-point number and corresponding second floating-point numbers and a maximum of the sums of the exponents.

3. The computing method of claim 2, wherein the selecting step comprises excluding each pair of first floating-point number and corresponding second floating-point number having a delta exponent greater than a predetermined threshold value.

4. The computing method of claim 3, further comprising ascertaining the threshold value using a trained artificial neural network using training data and one or more test threshold values and determine accuracies of the outcomes for the respective test threshold values, and setting a test threshold value as the predetermined threshold value if the respective accuracy meets a predetermined criterion.

5. The computing method of claim 3, wherein the excluding step comprises using a control signal to disable supplying the pair of first and second floating-point numbers to a respective one of the multiply circuits.

6. The computing method of claim 3, wherein the excluding step comprises using a control signal to disable the respective one of the multiply circuits.

7. The computing method of claim 3, wherein the excluding step comprises setting the product between the mantissas of the first floating-point number and respective second floating-point number to 0.

8. The computing method of claim 7, wherein the setting the product to zero comprises:
connecting each of outputs of the multiply circuits for all of the first plurality of floating-point numbers and corresponding second plurality of floating-point numbers to a data input of a respective multiplexer;
supplying 0 to another data input of each of the multiplexers; and
operating each multiplexer connected to a respective one of the multiply circuits to select the data input supplied with 0 for each pair of first floating-point number and corresponding second floating-point number that has a delta exponent greater than the threshold value.

9. A computing method, comprising:
for a plurality of pairs of a first and second floating-point numbers, each of the first and second floating-point numbers having a respective mantissa and exponent, supplying to a respective one of a plurality of multiply circuits the mantissas of a subset of the plurality of pairs of first and second floating-point numbers, the subset of the plurality of pairs of first and second floating-point numbers each having a respective sum of the exponents of the first and second floating-point numbers, respectively, meeting a predetermined criterion;
generating, using each of the plurality of multiply circuits, a product of the mantissas of the respective pair of first and second floating-point numbers;
accumulating the product mantissas to generate a product mantissa partial sum;
combining the product mantissa partial sum and maximum product exponent to generate an output floating point number; and
for each of the remaining pairs of first and second floating-point numbers:
withholding the mantissas from respective multiply circuits;
disabling the respective multiply circuits; or
both.

10. The computing method of claim 9, wherein the accumulating step comprises aligning, using a plurality of shifters, the mantissa products so that the exponents of all products between the first and second floating-point numbers in the respective pairs equal to a maximum product exponent.

11. The computing method of claim 9, wherein the supplying a subset of the first plurality of floating-point numbers and corresponding subset of the second plurality of floating-point numbers comprises supplying a subset of the first plurality of floating-point numbers and corresponding subset of the second plurality of floating-point numbers at least in part based on a difference (“delta exponent”), between a sum of the exponents of each pair of the first floating-point number and corresponding second floating-point numbers and a maximum of the sums of the exponents.

12. The computing method of claim 11, wherein the supplying step comprises excluding each pair of first floating-point number and corresponding second floating-point number having a delta exponent greater than a predetermined threshold value.

13. The computing method of claim 9, wherein the excluding step comprises using a control signal to disable a register storing the pair of first and second floating-point numbers connected to a respective one of the multiply circuits.

14. The computing method of claim 12, wherein the excluding step comprises using a control signal to disable the respective one of the multiply circuits.

15. The computing method of claim 12, wherein the excluding step comprises setting the product between the mantissas of the first floating-point number and respective second floating-point number to 0.

16. A computing device, comprising:
a plurality of multiply circuits, each configured to receive as inputs a respective pair of first and second binary numbers, and generate a product of the received first and second binary numbers;
a plurality of multiplexers, each having a first and second data inputs and a select input, and configured to receive at the first data inputs the product generated by a respective one of the multiply circuits and at the second data inputs a second input, and selectively output the received product or the second input;
an accumulator configured to generate a sum of a plurality of binary numbers, each indicative of the output of a respective one of the plurality of multiplexers; and
a plurality of comparators, each having a first and second inputs and an output, and configure to receive at the first input a respective input signal and receive at the second input a common input signal for all comparators,
the select inputs of the multiplexers being connected to the outputs of respective ones of the plurality of comparators.

17. The computing device of claim 16, wherein the accumulator comprises:
a plurality of shifters, each configured to receive as an input the output from a respective one of the multiplexers and configured to generate an output; and
an adder configured to generate a sum of the outputs from the shifters.

18. The computing device of claim 16, wherein the outputs of each of the comparators is connected to a respective one of the multiply circuits to enable or disable the respective multiply circuit depending on a state of the output of the comparator.

19. The computing device of claim 16, further comprising a plurality of registers, each configured to receive as inputs, store, and output to a respective one of the plurality of multiply circuits a respective pair of the first and second binary numbers, wherein the output of each of the comparators is connected to a respective one of the registers to enable or disable the output of the respective register depending on a state of the output of the comparator.

20. The computing device of claim 17, wherein the output of each of the comparators is connected to a respective one of the shifters to enable or disable the shifter depending on a state of the output of the comparator.
